(19) United States
(12) Patent Application Publication
(10) Pub. No.: US 2026/0257413 A1
(43) Pub. Date: Sep. 3, 2026

(54) LINER FOR AN EXTRUDER

(71) Applicant: Bühler AG, Uzwil (CH)

(72) Inventors: Patrick ROHRER, Henggart (CH); Miguel TARTAGLIA, Engelburg (CH)

(21) Appl. No.: 19/155,799

(22) PCT Filed: Feb. 16, 2024
(86) PCT No.: PCT/EP2024/025078

§ 371 Date: Aug. 12, 2025

(30) Foreign Application Priority Data
Feb. 17, 2023 (EP) 23157392.4

(51) Int. Cl. B29C 48/68; B29C 48/80

(52) U.S. Cl. CPC B29C 48/6803; B29C 48/834

(57) ABSTRACT

A liner for an extruder, comprising an inner part having a process zone which extents axially through the inner part, and a sealing sleeve which completely surrounds the inner part, wherein the inner part has at least one cooling channel. The present invention further relates to a barrel for an extruder, comprising an outer housing and a through-hole, wherein a liner according to the invention is arranged in the through-hole, and an extruder comprising at least one such barrel.

The present invention relates to a liner for an extruder, wherein the liner is exchangeable and has at least one cooling channel.

Extruders are machines in which materials, such as polymers, elastomers or protein-containing mixtures, can be treated for the production of foodstuffs, including cereals, snacks, animal feeds and alternative foods under desired pressure and temperature conditions. A typical extruder comprises at least one extruder screw shaft, wherein each of the extruder screw shafts has a set of extruder screw elements mounted on the shaft. The extruder screw shafts are accommodated in a cylinder, which is referred to as a barrel. An extruder usually comprises a plurality of barrels, which are connected to one another at the end. A plurality of barrels are required in order to carry out the different processes to be carried out in the extruder, such as conveying, kneading, mixing, degassing, dosing and the like.

Each barrel comprises an insert element referred to as a liner, which insert element is pressed into the barrel housing. In the barrel housing, channels for a medium are furthermore provided in order to regulate the temperature in the barrel within a desired range. The medium guided in the channels can be brought to a desired temperature by temperature control devices such as heat exchangers.

The liners comprise a process zone in form of an axial bore in which at least one extruder screw shaft is arranged and in which the desired treatment of the material to be extruded takes place. Since the extruder screw shaft rotates within the process zone during extrusion and in the process comes into contact with the surface of the process zone of the liner, wear of the liner occurs over time.

In order to ensure a proper extrusion process, the liners must therefore be replaced after a certain time. Since the liners are usually pressed into the barrel housing as explained above, the replacement of a liner in conventional barrels is a laborious process. Typically, the liner is pressed in by shrinking the liner into the barrel housing, which leads to such a fixed arrangement of the liner in the barrel housing that the entire system of liner and barrel housing replaced in the event of wear. This is obviously disadvantageous.

It was proposed, for example, in US 2011/0063939 A1 to provide an extruder in which liners are arranged replaceably in the barrels. The proposed solution comprises a barrel consisting of two parts which can be detached from one another in order to be able to exchange a liner arranged in the barrel.

This solution is still not optimal. On the one hand, special two-part barrels are required. On the other hand, the temperature control within the barrel is not optimal. During extrusion, heat is produced in the process zone of the liner, which has to be dissipated. The cooling channels provided in the barrels are spaced apart from the exchangeable liners and cool the process zone of the liner only indirectly.

The object of the present invention was to provide a liner for an extruder which overcomes the disadvantages of the prior art and, in particular, in addition to easier replaceability, has increased temperature control efficiency.

The object is achieved by a liner according to the present invention.

In detail, the present invention relates to a liner for an extruder, comprising an inner part with a process zone extending axially through the inner part, and a sealing sleeve completely circumferentially surrounding the inner part, characterized in that the inner part has at least one cooling channel.

The liner according to the invention is of modular design. The liner according to the invention comprises a sealing sleeve and an inner part arranged in the sealing sleeve.

The sealing sleeve preferably has an outer cylindrical shape and is designed such that it can be arranged in a preferably cylindrical through-hole of a barrel of an extruder and can be removed therefrom again. This can be achieved in that the outer diameter of the sealing sleeve is slightly (preferably 0.01 to 0.5%) smaller than the diameter of the through-hole of the barrel and thus the sealing sleeve has some “play” in the through-hole of the barrel.

The sealing sleeve is made of a material that is conventionally used for liners of extruders. The sealing sleeve is preferably made of a metal or a metal alloy. For example, iron, steel or alloys may be mentioned which contain aluminum, chromium, molybdenum, or combinations of these metals.

The sealing sleeve completely circumferentially surrounds the preferably cylindrical inner part of the liner according to the invention, so that the inner part does not come into contact with the housing of the barrel.

According to a preferred embodiment of the present invention, the sealing sleeve is fixedly applied to the inner part. In this embodiment, inner part and sealing sleeve cannot be exchanged separately from one another, but form an inseparable unit.

The inner part is also made of a material that is conventionally used for liners of extruders. The inner part is preferably made of a metal or a metal alloy. For example, iron, steel or alloys may be mentioned which contain aluminum, chromium, molybdenum, or combinations of these metals.

The connection between the sealing sleeve and the inner part can be produced in a conventional manner. According to a preferred embodiment, the sealing sleeve and the inner part are cast parts and the sealing sleeve is shrunk onto the inner part and optionally soldered or welded.

The inner part comprises a process zone which extents axially through the inner part, in the form of a continuous bore in which at least one extruder screw is arranged. According to a preferred embodiment, the process zone is selected from the group consisting of a cylindrical process zone and two partially overlapping cylindrical process zones. This corresponds to the Design of a single-shaft extruder or a twin-shaft extruder. However, the present invention is not limited to these variants, but can also be used in multi-shaft extruders having more than two extruder screws.

The embodiment of the liner according to the invention makes it possible in a simple manner to arrange at least one cooling channel in the inner part of the liner according to the invention. Since the inner part is preferably manufactured separately from the sealing sleeve, the at least one cooling channel can be provided in the inner part before the sealing sleeve is applied to the inner part. According to a preferred embodiment, more than one cooling channel, for example 2 to 10 cooling channels, can be provided in the inner part. These cooling channels may be connected to one another or have overlaps. According to the invention, each cooling channel preferably has a diameter in the range from 5 to 20 mm, more preferably 8 to 12 mm.

Compared to the prior art, the at least one cooling channel is arranged closer to the process zone of the liner, since it is provided directly in the inner part of the liner as explained above (and not, as in the prior art, in the barrel housing). This results in a significant improvement in the temperature control efficiency.

The at least one cooling channel can be a bore or groove which extends axially through the or outside on the inner part and is arranged parallel to the process zone.

According to a preferred embodiment according to the invention, the at least one cooling channel is arranged in or on the surface of the inner part. Particularly preferably, the at least one cooling channel is arranged in the form of a cooling coil in the surface of the inner part. This embodiment is particularly advantageous in production. Preferably, the at least one cooling channel is provided as a cooling channel part in the surface of the inner part, particularly preferably as an outwardly open channel. The at least one cooling channel part is produced during the production of the inner part, for example, by casting the inner part in a casting mold which generates corresponding cooling channel parts in the surface of the inner part. The at least one cooling channel part in the surface of the inner part is then closed outwardly by the above-described application of the sealing sleeve onto the inner part and forms the complete cooling channel.

The liner according to the invention preferably has elements with which liner according to the invention can be connected to one another at the end face. For this purpose, positioning bores, in which fastening elements such as screws or pins can be arranged, may be provided, for example, at the two ends of the inner part and/or the sealing sleeve, preferably of the inner part. The inner part of the liner according to the invention preferably has 2 to 10, particularly preferably 2 to 6, positioning bores on each end face.

According to a further preferred embodiment of the present invention, the liner has at least one radial bore which extends through the sealing sleeve and the inner part into the process zone. In this way, at least one radial through-channel is formed which may be a material inlet or may be used to arrange a measuring device.

For example, water or a gas can be introduced into the material to be extruded located in the process zone through a through-channel designed in this way in order, for example, to adjust the moisture content of the material to be extruded or to generate a pore formation in the material to be extruded.

The liner according to the invention is not particularly limited with regard to the number and position of these radial bores. For example, 2 to 10, preferably 3-6, radial bores may be provided parallel or offset to one another. The diameter of a radial bore is preferably in the range of 1 mm to 5 cm.

As described above, the liner according to the invention is arranged in a barrel. The present invention therefore also relates to a barrel for an extruder, comprising an outer housing and a through-hole, characterized in that a liner according to the present invention is replaceably arranged in the through-hole.

According to the present invention, a barrel conventionally used for extruders can be used. The barrel may have a square or cylindrical shape, wherein a cylindrical shape is preferred. The barrel is made of a material that is conventionally used for barrels of extruders. The barrel is preferably made of a metal or a metal alloy. For example, iron, steel or alloys may be mentioned which contain aluminum, chromium, molybdenum, or combinations of these metals.

Components such as flanges may be arranged at the end of the barrel; these preferably serve for the end-face connection of barrels. For this purpose, for example, positioning bores may be provided in these components, preferably flanges, in which fastening elements such as screws or pins may be arranged. Preferably, each component, preferably each flange, of the barrel according to the invention has 2 to 20, particularly preferably 2 to 16 positioning bores.

According to the present invention, both the liners (preferably via their inner parts) and the barrels are thus preferably connected to one another (via components such as flanges).

The barrel has a through-hole. The through-hole passes through the barrel axially through its entire length. In this through-hole, a liner according to the present invention is replaceably arranged. As already described above, this can be achieved in that the outer diameter of the sealing sleeve of the liner is slightly (preferably 0.01 to 0.5%) smaller than the diameter of the through-hole of the barrel and thus the sealing sleeve has some “play” in the through-hole of the barrel.

The barrel preferably has a length which corresponds to the length of the liner according to the invention. In other words, the end of the liner termi-nates flush with the end of the barrel, when the liner is arranged in the barrel. However, according to another preferred embodiment of the present invention, it is also possible for the axial length of the barrels to fall below the axial length of the liners, so that only the liners are subsequently connected to one another without an intermediate space between the liners, whereas a small gap of preferably 0.1 mm to 6 mm is formed between two successive barrels.

According to a further preferred embodiment of the present invention, the barrel has at least one radial bore which forms a radial through-channel with the radial bore of the liner described above.

In this way, at least one radial through-channel is formed which may be a material inlet or may be used to arrange a measuring device.

For example, water or a gas can be introduced into the material to be extruded located in the process zone through a through-channel designed in this way in order, for example, to adjust the moisture content of the material to be extruded or to generate a pore formation in the material to be extruded.

Alternatively, a measuring device may be arranged in a through-channel designed in this way, for example, for determining the pressure or the temperature in the process zone of the liner. Such measuring devices are known and need not be explained in more detail.

The barrel according to the invention is not particularly limited with regard to the number and position of these radial bores. For example, 2 to 10, preferably 3-6, radial bores may be provided parallel or offset to one another. The diameter of a radial bore is preferably in the range of 1 mm to 5 cm.

The above-described barrel can be used in any conventional extruder. The present invention therefore also relates to an extruder comprising at least one barrel described above.

According to the invention, the extruder comprises 2 to 20 barrels, preferably 2 to 15 barrels. As described above, the barrels are preferably connected to one another at the end face. According to a preferred embodiment of the present invention, the liners arranged in the barrels are additionally connected to one another at the end face, as described above.

Extruders are well known. Reference is made, for example, to WO 2012/158023 A1 or to Bühler extruders, in particular twin-screw extruders. Such extruders preferably have an L/D ratio (total length to screw diameter) in the range of 12-60, preferably 20 to 40. According to the invention, the extruders are preferably operated at 100 to 1000 rpm, particularly preferably at 200 to 800 rpm, and particularly preferably at 20 to 400 rpm.

A suitable extruder comprises at least one unit for introducing raw materials into a first section of the extruder. If different raw materials are to be introduced into the extruder, a plurality of such units may also be provided. The extruder typically also has a water supply line, an oil supply line and optionally a steam supply line.

The housing of the extruder is preferably temperature-controlled. The material to be extruded is kneaded under pressure (usually from 1 to 400 bar, preferably from 1 to 200 bar) in order to form a homogeneous mixture. This usually requires an energy input of 10 to 160 Wh/kg, preferably 10 to 130 Wh/kg.

According to a preferred embodiment of the present invention, a cooling tool, such as a cooling nozzle, can be provided at the outlet of the extruder. Cooling tools for extruders are well known. A known distributor unit can preferably be arranged between the extruder and the cooling tool.

The present invention is described in more detail below on the basis of non-limiting exemplary embodiments with reference to figures. In the figures, the same reference signs designate the same elements. In the figures:

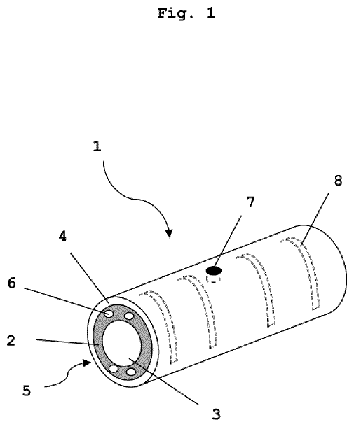

FIG. 1 shows a schematic view of an embodiment of an extruder according to the invention

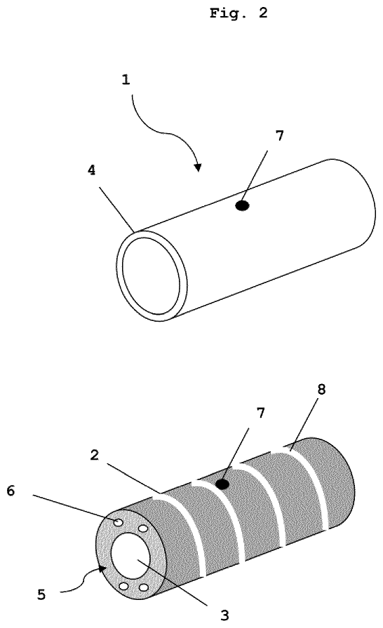

FIG. 2 shows a schematic view of the separate components of an embodiment of the liner according to the invention

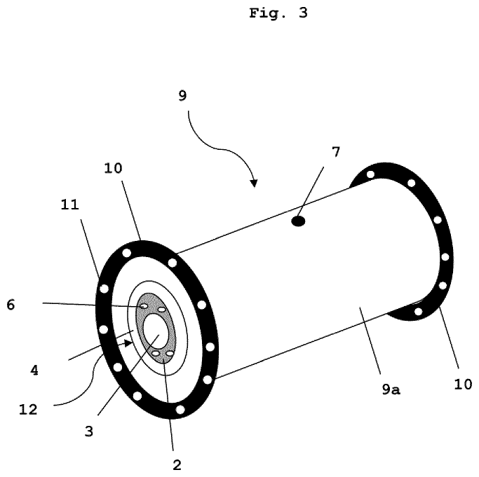

FIG. 3 shows a schematic view of an embodiment of the barrel according to the invention

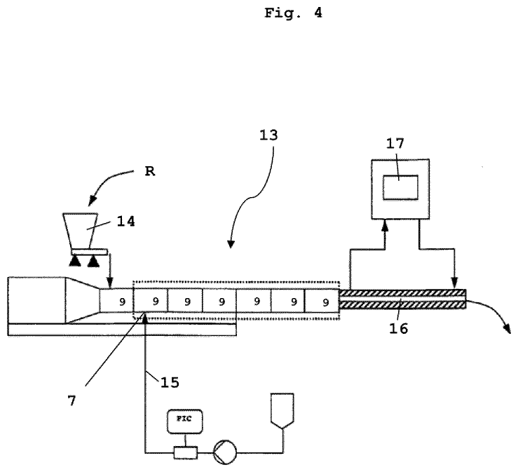

FIG. 4 shows a schematic view of an embodiment of an extruder according to the invention

FIG. 1 is a schematic view of an embodiment of an extruder 1 according to the invention. The liner 1 comprises an inner part 2 with a process zone 3 which extents axially through the inner part, and a sealing sleeve 4 which completely circumferentially surrounds the inner part 2. In this embodiment, inner part 2 and sealing sleeve 4 are cylindrical and made of a metal or a metal alloy. In this embodiment, the process zone 3 passing axially through the entire length of the liner 1 is also cylindrical and is intended for a single-shaft extruder. However, other process zones can also be provided, as described above. Positioning bores 6 are provided on the end faces 5 of the inner part 2 in order to connect a plurality of liners 1 to one another. The liner 1 also has a radial bore 7 which opens into the process zone 3.

The inner part 2 and the sealing sleeve 4 are cast parts. The sealing sleeve 4 is shrunk onto the inner part 2. It can be seen that, in the surface of the inner part 2 below the sealing sleeve 4, a channel-shaped cooling channel 8 (shown in dashed lines) is arranged, which passes spirally through the surface of the inner part 2 and is closed off outwardly by the sealing sleeve 4.

FIG. 2 shows a schematic view of the separate components of an embodiment of the liner 1 according to the invention.

It can be seen that a channel-shaped cooling channel 8 is arranged in the surface of the inner part 2, which channel-shaped cooling channel 8 passes spirally through the surface of the inner part 2 and is outwardly open. The cooling channel 8 is closed by the sealing sleeve 4 when the sealing sleeve 4 is applied to the inner part 2.

The radial bore 7 is present both in the inner part 2 and in the sealing sleeve 4 and opens into the process zone 3.

FIG. 3 show a schematic view of an embodiment of a barrel 9 according to the invention. The barrel 9 has an outer housing 9a and has, at both ends, one flange 10 each in which positioning bores 11 are provided in order to connect a plurality of barrels 9 to one another at the end face.

In this embodiment, the barrel 9 is cylindrical and made of a metal or a metal alloy.

An inner liner 1 according to FIG. 1 is arranged in the through-hole 12 of the barrel 9.

The radial bore 7 is also provided in the barrel 9, extents through the inner part 2 and the sealing sleeve 4 and opens into the process zone 3.

FIG. 4 is a schematic view of an embodiment of an extruder 13 according to the invention. The extruder 13 comprises a plurality of barrels 9. A raw material R can be supplied via the dosing unit 14. Water or steam can be introduced into the extruder 13 via a supply 15, preferably through a radial through-channel which is formed by a radial bore 7 in a barrel 9. In the embodiment according to FIG. 1, a cooling tool 16 is arranged at the end of the extruder 13. Of course, other conventional components may also be arranged at the end of the extruder. A cutting apparatus or an end plate with a subsequent cutting apparatus may be mentioned by way of example. The cooling medium is preferably supplied from a tank 17 at the downstream side of the cooling tool 16 and discharged at the upstream side of the cooling tool 16. The flow direction of the cooling medium is thus opposite to the flow direction of the extrudate.

### LIST OF REFERENCE SYMBOLS

1 Liner
2 Inner part
3 Process zone
4 Sealing sleeve
5 End face
6 Positioning hole
7 Radial bore
8 Cooling channel
9 Barrel
9a Outer housing
10 Flange
11 Positioning hole
12 Through-hole
13 Extruder
14 Dosing unit
15 Supply
16 Cooling tool
17 Tank

1. A liner for an extruder, comprising an inner part having a process zone which extents axially through the inner part, and a sealing sleeve which completely circumferentially surrounds the inner part, wherein the inner part has at least one cooling channel.

2. The liner according to claim 1, wherein the at least one cooling channel is arranged in the surface of the inner part.

3. The liner according to claim 2, wherein the at least one cooling channel is arranged in the form of a cooling coil in the surface of the inner part.

4. The liner according to claim 1, wherein the inner part is a cast piece made of metal.

5. The liner according to claim 1, wherein the sealing sleeve is fixedly applied to the inner part.

6. The liner according to claim 5, wherein the sealing sleeve is shrunk onto the inner part and optionally soldered or welded on.

7. The liner according to claim 1, wherein the process zone is selected from the group consisting of a cylindrical process zone and two partially overlapping cylindrical process zones.

8. The liner according to claim 1, wherein the liner has at least one radial bore which extends through the sealing sleeve and the inner part into the process zone.

9. A barrel for an extruder, comprising an outer housing and a through-hole, wherein an inner liner according to claim 1 is replaceably arranged in the through-hole.

10. The barrel according to claim 9, wherein the barrel has at least one radial bore which forms a radial through-channel with the radial bore of the liner.

11. The barrel according to claim 10, wherein the at least one radial through-channel is a material inlet or a measuring device is arranged in the radial through-channel.

12. An extruder comprising at least one barrel according to claim 9.

13. The extruder according to claim 12, wherein the extruder comprises 2 to 20 barrels, wherein the barrels are connected to one another at the end face.

14. The extruder according to claim 13, wherein additionally the liners arranged in the barrels are connected to one another at the end face.

15. The extruder according to claim 12, wherein the extruder is selected from the group consisting of a single-screw extruder and a twin-screw extruder, wherein the extruder screw(s) is/are arranged in the process zone of the liner(s).
